(19) United States
(12) Patent Application Publication
(10) Pub. No.: US 2005/0171644 A1
(43) Pub. Date: Aug. 4, 2005

(54) Autonomous mobile robot cleaner

(75) Inventor: Takao Tani, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/043,194

(22) Filed: Jan. 27, 2005

(30) Foreign Application Priority Data
Jan. 30, 2004 (JP) 2004-022410

(51) Int. Cl. G01C 21/00

(52) U.S. Cl. 700/253; 700/245; 701/25

(57) ABSTRACT

An autonomous mobile robot cleaner that can thoroughly clean areas along walls or other obstacles in a room. During a cleaning operation, the robot cleaner creates map information about already cleaned areas and areas where an obstacle is present and stores the map information in a memory. The robot cleaner performs a basic cleaning operation to clean areas while moving in the areas in accordance with a predetermined movement procedure. Subsequently, the robot cleaner performs an uncleaned area cleaning operation to clean uncleaned areas that cannot be cleaned by the basic cleaning operation, based on the map information. Thereafter, the robot cleaner performs an edge cleaning operation to clean the edge of an obstacle based on the map information.

### BACKGROUND OF THE INVENTION

1. Field of the Invention

The present invention relates to autonomous mobile robot cleaners that clean rooms as autonomously moving around.

2. Description of the Related Art

A known autonomous mobile robot cleaner (vacuum cleaner) operates as follows. The robot cleaner repeats moving straight and making a U-turn. When the robot cleaner becomes unable to make a U-turn or turn for backward movement, it searches for uncleaned areas based on a background map and a moving path thereof. If an uncleaned area is found, the robot cleaner cleans the uncleaned area (see, for example, Japanese laid-open patent publication Sho 62-154008). When an obstacle is present in a room to be cleaned by the robot cleaner or when the room is not square, there is a possibility that some uncleaned area is left at the time the robot cleaner becomes unable to make a U-turn or turn for backward movement. Therefore, the robot cleaner cleans such uncleaned area after becoming unable to make a U-turn or turn for backward movement.

The above conventional robot cleaner has the following problem. In general, when cleaning e.g. a room, robot cleaners structurally have difficulty in thoroughly cleaning an area along a wall or obstacle. Therefore, there is a possibility that such an area cannot be cleaned completely. However, the robot cleaner disclosed in the above reference fails to take countermeasures to thoroughly clean the area along a wall or obstacle.

### SUMMARY OF THE INVENTION

An object of the present invention is to provide an autonomous mobile robot cleaner that can thoroughly clean an area along a wall or other obstacle in a room.

According to a first aspect of the present invention, the above object is achieved by an autonomous mobile robot cleaner having a main body, comprising: an obstacle detection means to detect an obstacle around the main body; a moving means to move and turn the main body; a cleaning means to clean an area in which the main body moves; a cleaning operation control means to control the moving means and the cleaning means based on an output of the obstacle detection means so as to clean, while moving the main body, the area in which the main body moves; and a map information memory means to store map information about an area where an obstacle is present, wherein the cleaning operation control means performs a basic cleaning operation to move the main body in accordance with a predetermined movement procedure, and wherein thereafter the cleaning operation control means performs an edge cleaning operation to move the main body along the perimeter of the obstacle based on the map information stored in the map information memory means.

By such a configuration, the autonomous mobile robot cleaner cleans e.g. a room while moving along a moving path in accordance with the predetermined movement procedure based on the basic cleaning operation, and thereafter it cleans the edge of an obstacle based on the edge cleaning operation. Accordingly, the autonomous mobile robot cleaner cleans the edge of the obstacle twice by the basic cleaning operation and the edge cleaning operation so as to thoroughly clean the edge of the obstacle. Moreover, in the edge cleaning operation, the autonomous mobile robot cleaner cleans the edge of the obstacle while moving along the perimeter of the obstacle, thereby cleaning the edge of the obstacle more thoroughly.

Preferably, the autonomous mobile robot cleaner further comprises: a moving distance detection means to detect a moving distance of the main body; a moving direction detection means to detect a moving direction of the main body; and a map information creating means to create the map information based on outputs of the obstacle detection means, the moving distance detection means, and the moving direction detection means, wherein the cleaning operation control means performs the edge cleaning operation based on map information updated during the cleaning operation by the map information creating means. By such a configuration, since the map information is created during the cleaning operation, there is no need to input data about the shape of a room to be cleaned, an obstacle in the room, and the like prior to the cleaning operations.

Preferably, the map information creating means creates, during the basic cleaning operation, map information indicating an already cleaned area and an area where an obstacle is present. Preferably, after the basic cleaning operation, the cleaning operation control means performs an uncleaned area cleaning operation to move the main body in an area that is left uncleaned, based on map information updated during the basic cleaning operation by the map information creating means; the cleaning operation control means repeats the uncleaned area cleaning operation, until there is no uncleaned area, based on map information updated during the cleaning operations by the map information creating means; and after there is no uncleaned area, the cleaning operation control means performs the edge cleaning operation to move the main body along the perimeter of an obstacle based on updated map information.

By such a configuration, the autonomous mobile robot cleaner performs cleaning while moving based on the basic cleaning operation. During the basic cleaning operation, the autonomous mobile robot cleaner creates map information indicating already cleaned areas and areas where an obstacle is present. Thereafter, based on the map information, the autonomous mobile robot cleaner cleans an uncleaned area, which cannot be cleaned by the basic cleaning operation, by an uncleaned area cleaning operation. During the uncleaned area cleaning operation, the autonomous mobile robot cleaner continuously creates the map information, so that the uncleaned area cleaning operation is repeated until there is no uncleaned area. When there is no uncleaned area, the room has been entirely cleaned with the positions of all obstacles including walls in the room having been detected. After the autonomous mobile robot cleaner cleans the entire room by the basic cleaning operation and the uncleaned area cleaning operation, it cleans the edges of the obstacles by the edge cleaning operation, based on the map information at that time.

By repeating the uncleaned area cleaning operation, until there is no uncleaned area, based on map information updated during the cleaning operations, the autonomous mobile robot cleaner can clean the entire room, of whatever shape and in whatever manner obstacles are arranged therein, and then clean the edges of all of the obstacles.

### BRIEF DESCRIPTION OF THE DRAWINGS

FIG. 1A is a schematic and perspective top plan view of an autonomous mobile robot cleaner according to an embodiment of the present invention, and FIG. 1B is a schematic and partially cutaway side view of the autonomous mobile robot cleaner.

FIG. 2 is a schematic and perspective front view of the autonomous mobile robot cleaner.

FIG. 3 is an electrical block diagram of the autonomous mobile robot cleaner.

FIG. 4 is a flowchart showing a map creating process of the autonomous mobile robot cleaner.

FIG. 5 is a flowchart showing a cleaning operation control process of the autonomous mobile robot cleaner.

FIG. 6 is a flowchart showing a cleaning operation control process of the autonomous mobile robot cleaner.

FIG. 7 is a flowchart showing a cleaning operation control process of the autonomous mobile robot cleaner.

FIG. 8A schematically shows an example of movement in a basic cleaning operation and an uncleaned area cleaning operation of the autonomous mobile robot cleaner, and FIG. 8B schematically shows an example of movement in an edge cleaning operation of the autonomous mobile robot cleaner.

FIG. 9A through FIG. 9G are conceptual diagrams of map information in the autonomous mobile robot cleaner.

FIG. 10H through FIG. 10K are also conceptual diagrams of map information in the autonomous mobile robot cleaner.

### DETAILED DESCRIPTION OF THE PREFERRED EMBODIMENT

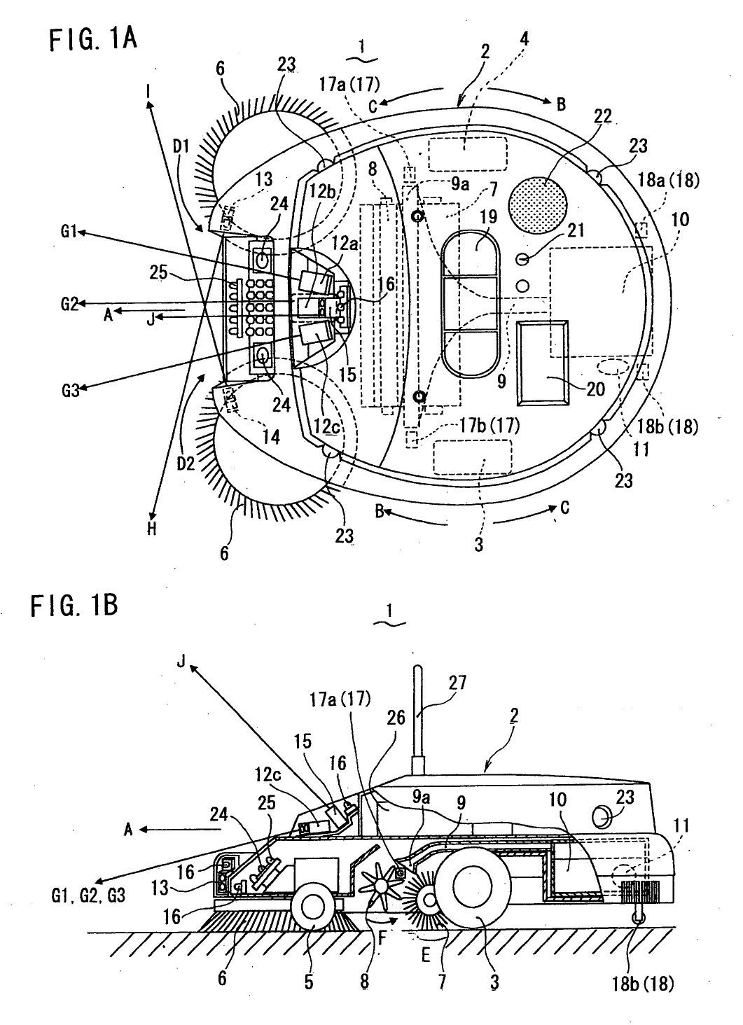

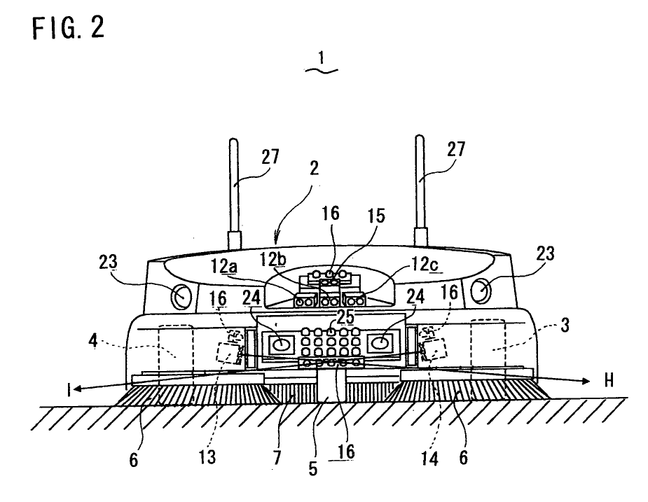

Referring now to the accompanying drawings, an embodiment of the present invention will be described. A schematic configuration of an autonomous mobile robot cleaner 1 (vacuum cleaner) according to the present embodiment is shown in FIG. 1A, FIG. 1B, and FIG. 2. The autonomous mobile robot cleaner 1 is a device that autonomously moves on a floor of a room to clean the floor, and comprises: a main body 2; a left wheel 3, a right wheel 4 and a front wheel 5 to move the main body 2; and auxiliary brushes 6, a main brush 7, a roller 8, a suction nozzle 9, a dust box 10 and a suction fan 11 to collect dust, dirt and so on to be sucked or collected by a cleaner (hereafter collectively referred to simply as dust) e.g. dropped on the floor. The autonomous mobile robot cleaner 1 further comprises front sensors 12a, 12b, and 12c, a left step sensor 13, a right step sensor 14, and a ceiling sensor 15 to detect obstacles around the main body 2 thereof, and sensor illumination lamps 16. An obstacle detection means according to the present embodiment comprises the front sensors 12a, 12b, and 12c, the left step sensor 13, the right step sensor 14 and the ceiling sensor 15.

The left wheel 3 and the right wheel 4 are drive wheels that are independently rotated in normal rotation and reverse rotation, while the front wheel 5 is an idler wheel. The autonomous mobile robot cleaner 1 moves in a front (forward) direction (direction of arrow A shown in FIG. 1A and FIG. 1B) when both the left wheel 3 and right wheel 4 are rotated in normal rotation at the same rotation speed. On the other hand, when one of the left wheel 3 and the right wheel 4 is rotated in normal rotation at an arbitrary position of the autonomous mobile robot cleaner 1 while the other is rotated in reverse direction at that position, the autonomous mobile robot cleaner 1 turns clockwise (direction of arrow B shown in FIG. 1A) or counterclockwise (direction of arrow C in FIG. 1A) at that position.

The auxiliary brushes 6 gather up the dust dropped on the floor, and two of them are provided at a front portion of the main body 2 that are respectively rotated in directions D1 and D2 shown in FIG. 1A. The main brush 7 gathers up the dust dropped on the floor to bring them upward, and is provided behind the auxiliary brushes 6 and rotated in direction E shown in FIG. 1B. The roller 8 transports the dust gathered up by the main brush 7 to the vicinity of a suction inlet 9a of the suction nozzle 9, and rotates in direction F shown in FIG. 1B, following the rotation of the main brush 7.

The suction nozzle 9 sucks the dust gathered up by the main brush 7 and the dust transported by the roller 8 from the suction inlet 9a, and exhausts them into the dust box 10. The suction inlet 9a of the suction nozzle 9 has a width elongated in a direction perpendicular to the moving direction (direction A shown in FIG. 1A and FIG. 1B) of the main body 2. The dust box 10 collects the dust exhausted from the suction nozzle 9.

The suction fan 11 exhausts air in the dust box 10 outside the main body 2 via a filter. Due to the exhaustion of air in the dust box 10 outside the main body 2 by the suction fan 11, the dust together with air is sucked from the suction inlet 9a of the suction nozzle 9, and is exhausted into the dust box 10. While moving around, the autonomous mobile robot cleaner 1 gathers up dust by the auxiliary brushes 6, and sucks the dust by the suction nozzle 9, whereby it cleans the area it moves around, namely its movement area.

Each of the front sensors 12a, 12b, and 12c, the left step sensor 13, the right step sensor 14, and the ceiling sensor 15 is an optical distance sensor. The front sensors 12a, 12b, and 12c detect obstacles and measure distances to the obstacles that are positioned in front of the main body 2 such as a step, a wall, a pillar, a book put on the floor, a table, a chair, and an electric fan. The front sensors 12a, 12b, and 12c monitor the area in front of the main body 2 downward diagonally (in directions G1, G2, and G3 shown in FIG. 1A and FIG. 1B).

The left step sensor 13 detects and measures distances to obstacles that are similar to those above and located left of the main body 2, and monitors the area slightly in front of and left of the main body 2 downward diagonally (in direction H shown in FIG. 1A and FIG. 2). On the other hand, the right step sensor 14 detects and measures distances to obstacles that are similar to those above and located right of the main body 2, and monitors the area slightly in front of and right of the main body 2 downward diagonally (in direction I shown in FIG. 1A and FIG. 2).

The ceiling sensor 15 detects obstacles located above and in front of the main body 2 of the autonomous mobile robot cleaner 1 (as to whether or not it can pass through under a table, a bed or the like) and measures heights of and distances to the obstacles. The ceiling sensor 15 monitors the area in front of the main body 2 upward diagonally (in direction J shown in FIG. 1A and FIG. 1B). The sensor illumination lamps 16 illuminate the area around the main body 2 so that the front sensors 12a, 12b, and 12c, the left step sensor 13, the right step sensor 14, and the ceiling sensor 15 can surely detect obstacles.

The autonomous mobile robot cleaner 1 further comprises: a dust sensor 17 to detect dust sucked by the suction nozzle 9; a carpet sensor 18 to detect whether or not the floor surface is carpet; an operating unit 19; an LCD (liquid crystal display) 20; an LED (light emitting diode) 21; and a speaker 22. The dust sensor 17 is an optical transmission sensor comprising a light emitting unit 17a to emit light and a light receiving unit 17b to receive the light from the light emitting unit 17a. The light emitting unit 17a and the light receiving unit 17b are provided on both sides of and in the vicinity of the suction inlet 9a of the suction nozzle 9. When the suction nozzle 9 sucks dust, the dust passes through between the light emitting unit 17a and the light receiving unit 17b. The light emitted from the light emitting unit 17a and received by the light receiving unit 17b is obstructed by the dust. Based on the light obstruction, the dust sensor 17 detects the dust sucked by the suction nozzle 9.

The carpet sensor 18 is also an optical transmission sensor comprising a light emitting unit 18a to emit light and a light receiving unit 18b to receive the light from the light emitting unit 18a. The light emitting unit 18a and the light receiving unit 18b are provided in a manner that they are separated from each other in a direction perpendicular to the moving direction of the main body 2, and that they are positioned at a height to allow a slight gap between them and the surface of the floor. When the main body 2 moves on the carpet, the fibers of the carpet obstruct between the light emitting unit 18a and the light receiving unit 18b, so that the light emitted from the light emitting unit 18a and received by the light receiving unit 18b is obstructed thereby. Based on the light obstruction, the carpet sensor 18 detects that the floor surface is carpet.

The operating unit 19 is operated by a user to start and stop the cleaning operation of the autonomous mobile robot cleaner 1, and to make various other settings. The LCD 20 informs, by character display, operational states of the autonomous mobile robot cleaner 1 and various messages. The LED 21 informs operational states of the autonomous mobile robot cleaner 1 by its three modes: off, on, and blinking. The speaker 22 informs, by audio output, operational states of the autonomous mobile robot cleaner 1 and various messages. These operating unit 19, LCD 20, LED 21 and speaker 22 are provided on an upper portion of the main body 2.

The autonomous mobile robot cleaner 1 furthermore has a security function of monitoring e.g. intruders, and comprises: human sensors 23 to detect e.g. the intruders; cameras 24 to photograph e.g. the intruders; camera illumination lamps 25; and a wireless communication module 26. The human sensors 23 detect presence or absence of a human body around the main body 2 of the autonomous mobile robot cleaner 1 by receiving infrared radiation from the human body. The cameras 24 are each provided to face in a direction diagonally forward and upward from the main body 2 so that they can photograph faces of standing humans. The camera illumination lamps 25 each illuminate in a direction diagonally forward and upward from the main body 2 (namely the photographing direction of the cameras 24) so as to enable sure photographing by the cameras 24. The wireless communication module 26 wirelessly transmits images photographed by the cameras 24 to e.g. a monitoring center via an antenna 27. When not in the cleaning operation, the autonomous mobile robot cleaner 1 operates these human sensors 23, cameras 24, camera illumination lamps 25, and wireless communication module 26 so as to monitor e.g. the intruders.

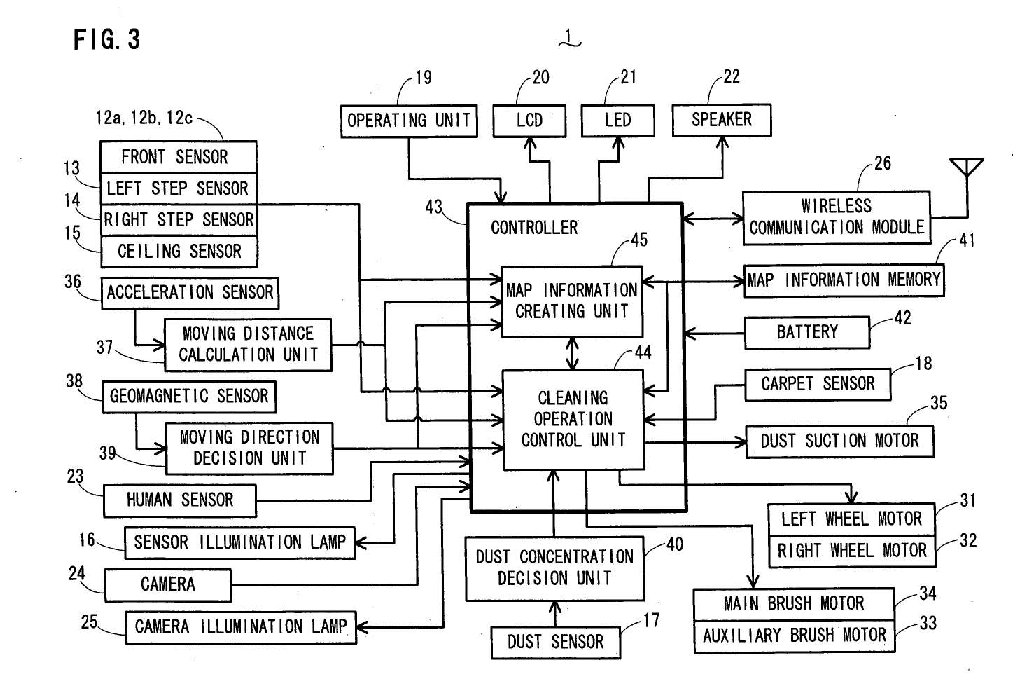

Referring now to FIG. 3 which shows an electrical block diagram of the autonomous mobile robot cleaner 1, its configuration and operation will be described. As described above, the autonomous mobile robot cleaner 1 comprises the front sensors 12a, 12b, and 12c, the left step sensor 13, the right step sensor 14, the ceiling sensor 15, the sensor illumination lamps 16, the dust sensor 17, the carpet sensor 18, the operating unit 19, the LCD 20, the LED 21, the speaker 22, the human sensors 23, the cameras 24, the camera illumination lamps 25, and the wireless communication module 26. In addition to these, the autonomous mobile robot cleaner 1 comprises: a left wheel motor 31, a right wheel motor 32, an auxiliary brush motor 33, a main brush motor 34, a dust suction motor 35, an acceleration sensor 36, a moving distance calculation unit 37, a geomagnetic sensor 38, a moving direction decision unit 39, a dust concentration decision unit 40, a map information memory 41 (map information memory means), a battery 42, and a controller 43 to control the above respective units and elements.

A moving means according to the present embodiment comprises the left wheel motor 31, the right wheel motor 32, and the above described left wheel 3 and right wheel 4. A cleaning means according to the present embodiment comprises the auxiliary brush motor 33, the main brush motor 34, the dust suction motor 35, and the above described auxiliary brushes 6, main brush 7, roller 8, suction nozzle 9, dust box 10, and suction fan 11. Furthermore, a moving distance detection means according to the present embodiment comprises the acceleration sensor 36 and the moving distance calculation unit 37, while a moving direction detection means according to the present embodiment comprises the geomagnetic sensor 38 and the moving direction decision unit 39.

As described above, the front sensors 12a, 12b, and 12c, the left step sensor 13, the right step sensor 14, and the ceiling sensor 15 detect an obstacle, and measure the distance to the obstacle. The measured values are input to the controller 43. Under the control of the controller 43, the sensor illumination lamps 16 emit illumination lights. The dust sensor 17 detects dust as described above, and the detected signals, as outputs of the dust sensor 17, are input to the dust concentration decision unit 40. The carpet sensor 18 detects that the floor surface is carpet as described above, and the detected signals are input to the controller 43. The operating unit 19 outputs operation signals in accordance with operations of the operating unit 19 by a user, and the operation signals are input to the controller 43. Under the control of the controller 43, the LCD 20, the LED 21, and the speaker 22 inform operational states of the autonomous robot cleaner 1 and various messages.

The human sensors 23 detect presence or absence of a human body as described above, and the detected signals are input to the controller 43. Under the control of the controller 43, the cameras 24 photograph while the camera illumination lamps 25 emit illumination lights also under the control of the controller 43. Furthermore, under the control of the controller 43, the wireless communication module 26 wirelessly transmits images photographed by the cameras 24.

The left wheel motor 31 rotates the above left wheel 3 in both normal and reverse rotations, while the right wheel motor 32 rotates the above right wheel 4 also in both and reverse rotations. The auxiliary brush motor 33 rotates the above auxiliary brushes 6, while the main brush motor 34 rotates the above main brush 7. The dust suction motor 35 rotates the above suction fan 11. These left wheel motor 31, right wheel motor 32, auxiliary brush motor 33, main brush motor 34 and dust suction motor 35 are respectively rotated under the control of the controller 43.

The acceleration sensor 36 detects accelerations acting on the main body 2, and outputs output values in accordance with the detected accelerations. More specifically, the acceleration sensor 36 independently detects accelerations acting on the main body 2 in up-down direction, forward-backward direction, and left-right direction, respectively, and outputs output values in accordance with the detected accelerations in the up-down, forward-backward, and left-right directions, respectively. The moving distance calculation unit 37 calculates a moving speed of the main body 2 based on the output value of the acceleration sensor 36 in the forward-backward direction, and calculates a moving distance of the main body 2 based on the calculated moving speed.

The geomagnetic sensor 38 detects the geomagnetic field, and outputs output values in accordance with the direction of the geomagnetic field. Based on an output value of the geomagnetic sensor 38, the moving direction decision unit 39 decides the then direction in which the main body 2 faces, namely moving direction of the main body 2, using the direction of the geomagnetic field as a reference.

The dust concentration decision unit 40 detects an amount of dust collection per a given time based on the output of the dust sensor 17, thereby deciding degree of dust concentration on the floor surface. The map information memory 41 stores map information about areas where an obstacle is present and about already cleaned areas. The battery 42 supplies power to the above respective units and elements.

The controller 43 controls the above respective units an elements, and comprises: a cleaning operation control unit 44 (cleaning operation control means) to control the cleaning operation; and a map information creating unit 45 (map information creating means) to create map information about areas where an obstacle is present and already cleaned areas.

The cleaning operation control unit 44 controls the rotations of the left wheel 3 and the right wheel 4 by controlling the rotations of the left wheel motor 31 and the right wheel motor 32 so as to control the movement and turning of the main body 2. The cleaning operation control unit 44 further controls the rotations of the auxiliary brushes 6, the main brush 7, and the suction fan 11 by controlling the rotations of the auxiliary brush motor 33, the main brush motor 34, and the dust suction motor 35 so as to control the dust collection operation.

The cleaning operation control unit 44 controls the movement and the dust collection operation of the main body 2, thereby performing the cleaning operation while moving the main body 2. In the cleaning operation, the cleaning operation control unit 44 performs (1) an initial operation to turn the main body 2 of the autonomous mobile robot cleaner 1 360 degrees at a cleaning start position for determining whether or not an obstacle is present around the cleaning start position; (2) a basic cleaning operation to perform cleaning while moving the main body 2 from the cleaning start position in accordance with a predetermined movement procedure; (3) an uncleaned area cleaning operation to clean, after the basic cleaning operation, an uncleaned area that cannot be cleaned by the basic cleaning operation; and (4) an edge cleaning operation to clean an edge of an obstacle while moving the main body 2 along the perimeter of the obstacle. The cleaning operation control unit 44 performs the above initial operation, basic cleaning operation, uncleaned area cleaning operation, and edge cleaning operation based on outputs of the front sensors 12a, 12b, and 12c, the left step sensor 13, the right step sensor 14, and the ceiling sensor 15 and based on the map information stored in the map information memory 41.

The map information creating unit 45 creates map information that allows already cleaned areas and areas where an obstacle is present to be managed like a matrix, and stores the map information in the map information memory 41. In addition, the map information creating unit 45 stores position information indicating a current position of the main body 2 in the map information memory 41. At the time of the initial operation and during the basic cleaning operation, uncleaned area cleaning operation, and edge cleaning operation, the map information creating unit 45 updates the map information and the position information at all times based on outputs of the front sensors 12a, 12b, and 12c, the left step sensor 13, the right step sensor 14, the ceiling sensor 15, the moving distance calculation unit 37, the moving direction decision unit 38, and the cleaning operation control unit 44.

As the map information and position information stored in the map information memory 41 is updated at all times during the cleaning operations, the cleaning operation control unit 44 controls subsequent cleaning operations while reading the updated map information and position information. Based on outputs of the carpet sensor 18 and the dust concentration decision unit 40, the cleaning operation control unit 44 controls the rotations of the left wheel motor 31 and the right wheel motor 32 so as to adjust the moving speed of the main body 2, and furthermore controls the rotations of the auxiliary brush motor 33, the main brush motor 34, and the dust suction motor 35 so as to adjust the dust collecting power.

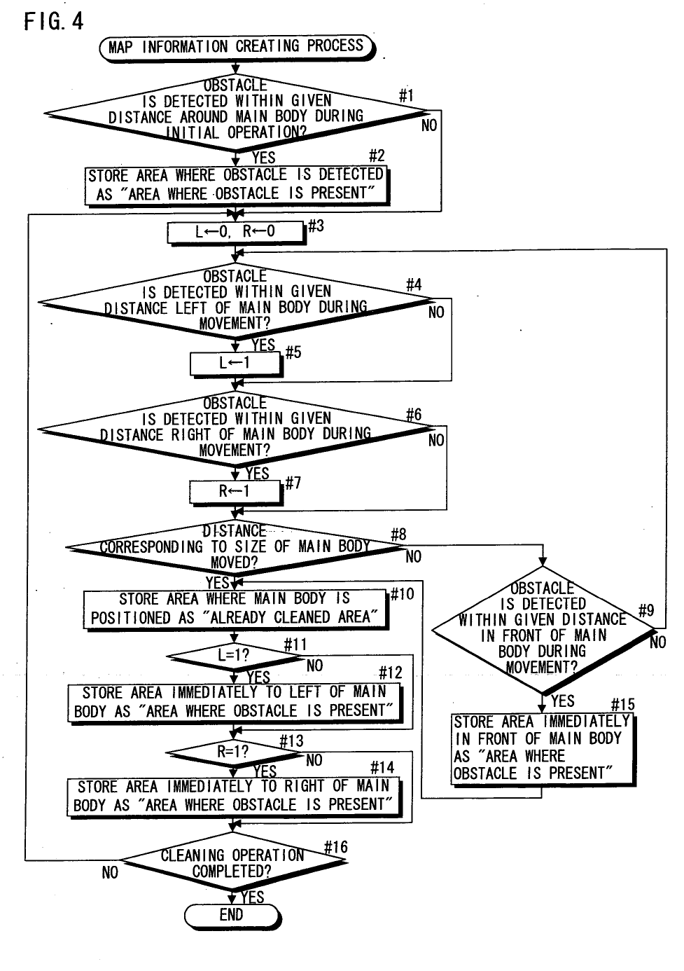

Referring now to the flowchart of FIG. 4, a map information creating process by the map information creating unit 45 will be described. When the cleaning operation control unit 44 starts a cleaning operation, the map information creating unit 45 starts creating map information.

While the main body 2 is turned 360 degrees at a cleaning start position, i.e., while the above described initial operation is performed, the map information creating unit 45 determines whether or not an obstacle is detected within a given distance (e.g. 5 cm) around the main body 2 based on outputs of the front sensors 12a, 12b, and 12c and the ceiling sensor 15 (#1). If an obstacle is detected (YES at #1), the map information creating unit 45 stores in the map information memory 41 an area adjacent to the main body 2 in the direction where the obstacle is detected as an “area where an obstacle is present” (#2).

Subsequently, the map information creating unit 45 sets each of the values of parameters “L” and “R” at “0” (#3). It is noted that the parameter “L” is provided to indicate whether or not an obstacle is detected within a given distance (e.g. 5 cm) left of the main body 2, while the parameter “R” is provided to indicate whether or not an obstacle is detected within a given distance (e.g. 5 cm) right of the main body 2. After the setting is performed, the basic cleaning operation is started under the control of the cleaning operation control unit 44 so that the main body 2 starts movement.

Thereafter, the map information creating unit 45 determines based on an output of the left step sensor 13 whether or not an obstacle is detected within a given distance left of the main body 2 while the main body 2 moves (#4). If such an obstacle is detected (YES at #4), the map information creating unit 45 sets the value of “L” at “1” (#5). Further, the map information creating unit 45 determines based on an output of the right step sensor 14 whether or not an obstacle is detected within a given distance right of the main body 2 while the main body 2 moves (#6). If such an obstacle is detected (YES at #6), the map information creating unit 45 sets the value of “R” at “1” (#7).

Subsequently, the map information creating unit 45 determines based on an output of the moving distance calculation unit 37 whether or not the main body 2 has moved a distance corresponding to the size of the main body 2 (#8). If the main body 2 has not moved such a distance yet (NO at #8), the map information creating unit 45 determines based on outputs of the front sensors 12a, 12b, and 12c and the ceiling sensor 15 whether or not an obstacle is detected within a given distance (e.g. 5 cm) in front of the main body 2 (#9). If the main body 2 has not moved a distance corresponding to the size thereof yet (NO at #8) and no obstacle has been detected within the given distance in front of the main body 2 (NO at #9), the process returns to the step #4. In other words, the process of the steps #4 to #7 is repeated until the main body 2 moves a distance corresponding to the size of the main body 2 or an obstacle is detected in front of the main body 2.

When the main body 2 has moved a distance corresponding to the size of the main body 2 (YES at #8), the map information creating unit 45 stores the area in which the main body 2 is positioned at that time as an “already cleaned area” in the map information memory 41 (#10). At the same time, if the value of “L” is “1” (YES at #11), the map information creating unit 45 stores the area immediately to the left of the main body 2 as an “area where an obstacle is present” in the map information memory 41 (#12), and further if the value of “R” is “1” (YES at #13), the map information creating unit 45 stores the area immediately to the right of the main body 2 as an “area where an obstacle is present” in the map information memory 41 (#14).

On the other hand, if an obstacle is detected within the given distance (e.g. 5 cm) in front of the main body 2 (YES at #9) before the main body 2 moves a distance corresponding to the size thereof (NO at #8), the map information creating unit 45 stores the area immediately in front of the main body 2 as an “area where an obstacle is present” in the map information memory 41 (#15), and performs the process of the steps #10 to #14.

Thereafter, if the cleaning operation by the cleaning operation control unit 44 has not been completed (NO at #16), the map information creating unit 45 repeats the process from the step #3. In other words, as long as the cleaning operation is continued, the above process of the steps #3 to #15 is repeated. By this process, every time the main body 2 moves a distance corresponding to the size thereof during the cleaning operation (or at the time an obstacle is detected in front of the main body 2), an “already cleaned area” and/or an “area where an obstacle is present” are added in the map information memory 41 for update of map information. When the cleaning operation by the cleaning operation control unit 44 ends (YES at #16), the map information creating unit 45 ends the map information creating process.

As described above, every time the autonomous mobile robot cleaner 1 moves a distance corresponding to the size of the main body 2 thereof, the map information creating unit 45 stores an “already cleaned area” and/or an “area where an obstacle is present” in the map information memory 41 so as to create the map information. During the cleaning operation, the autonomous mobile robot cleaner 1 moves in two directions perpendicular to each other under the control of the cleaning operation control unit 44 as described below. Accordingly, in the map information created by the map information creating unit 45, “already cleaned areas” and “areas where an obstacle is present” are managed like a matrix in units of the size of the main body 2.

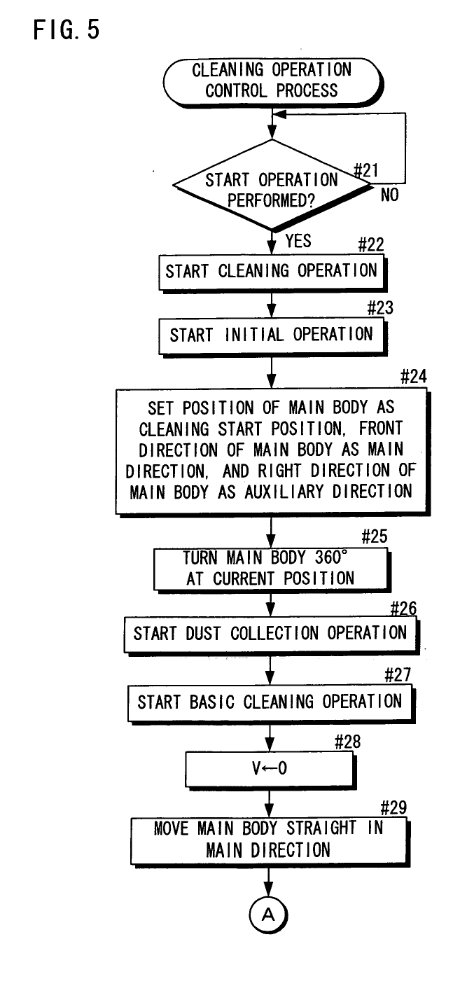

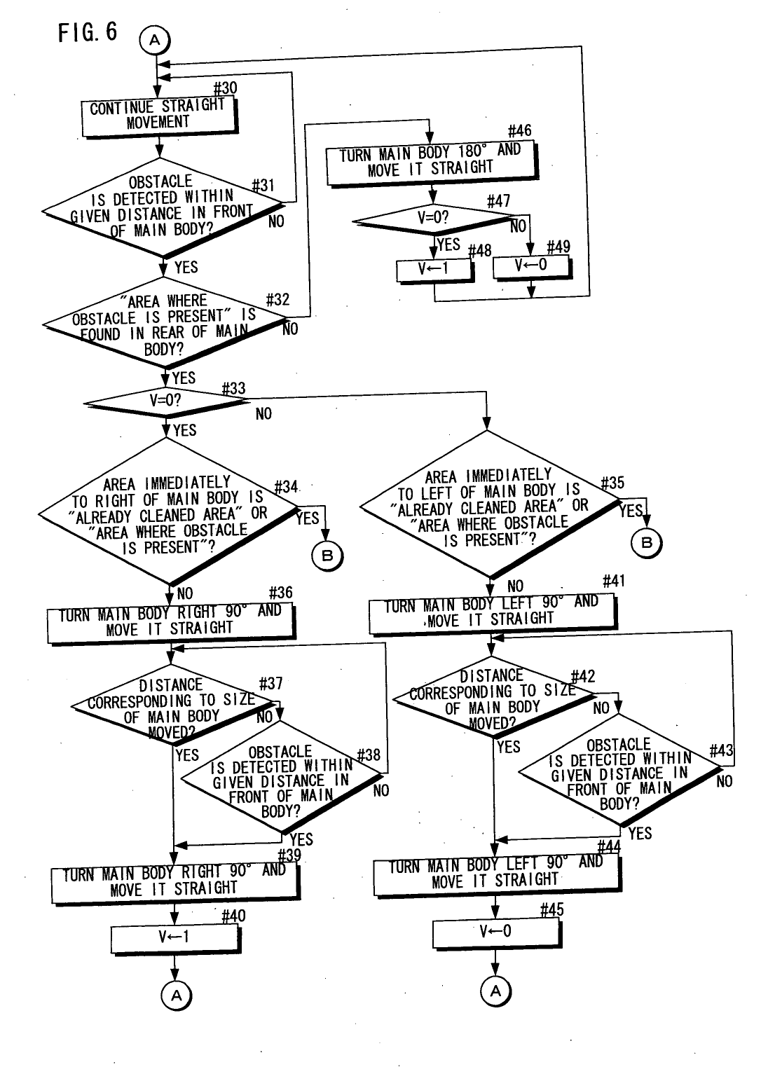

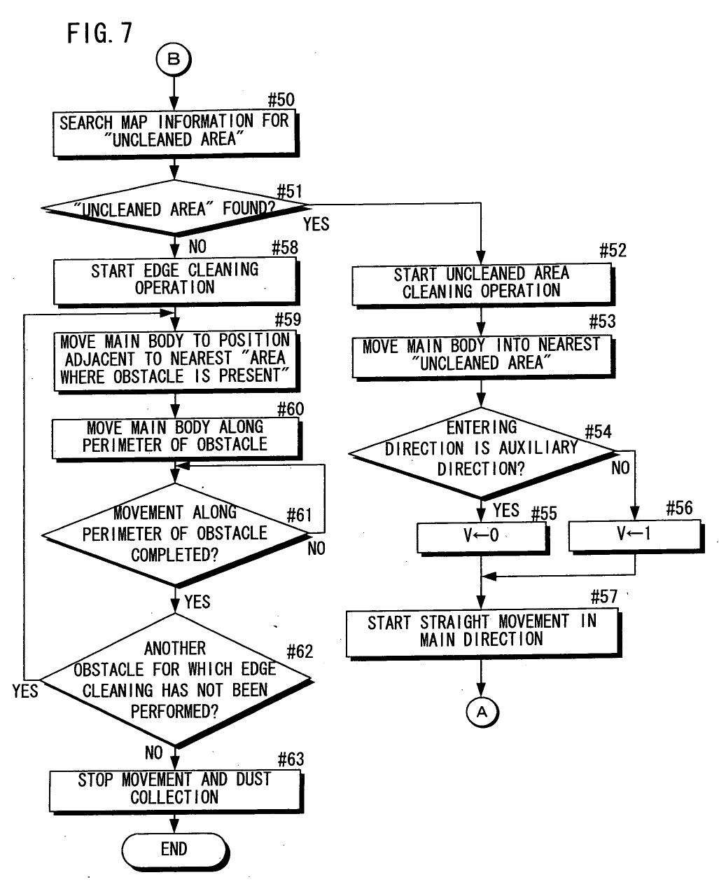

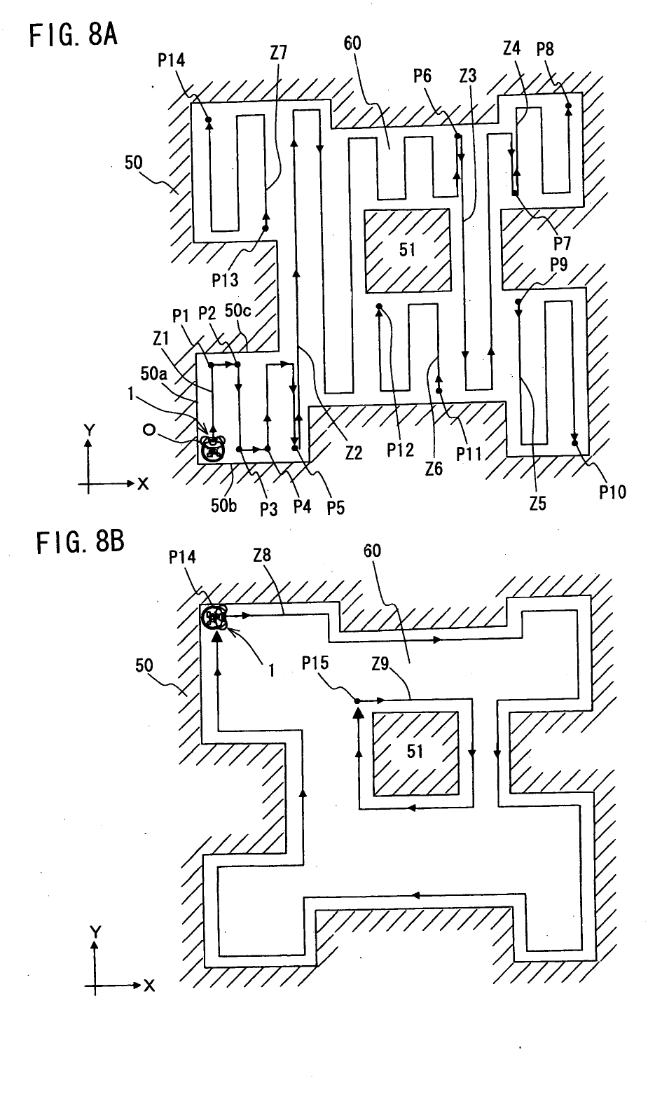

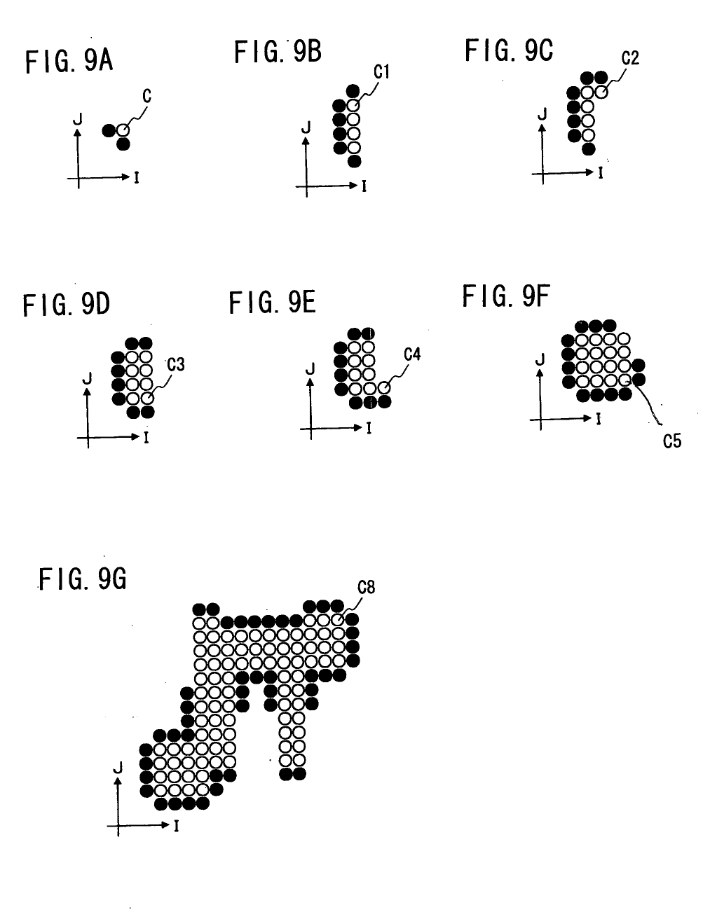

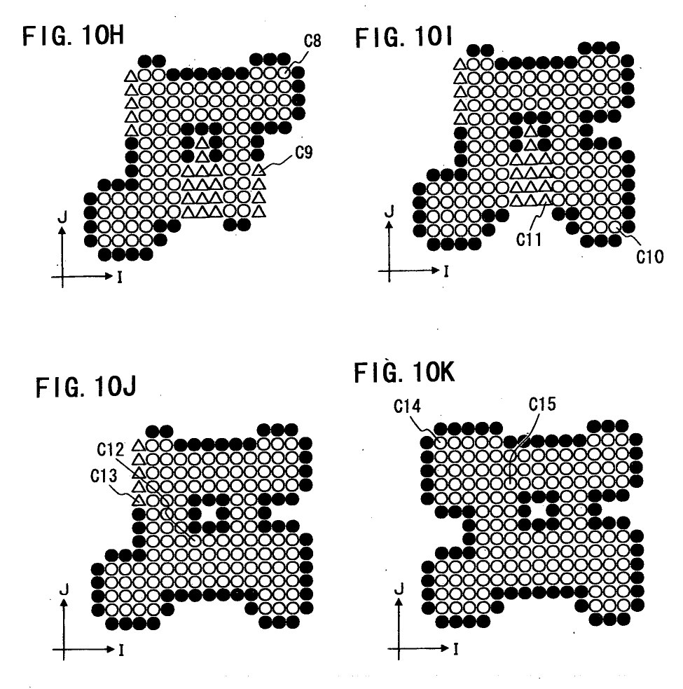

Hereinafter, the cleaning operation by the cleaning operation control unit 44 will be described referring to the flowcharts shown in FIG. 5 through FIG. 7, examples of movements of the autonomous mobile robot cleaner 1 as shown in FIG. 8A and FIG. 8B, and map information conceptually shown in FIG. 9A through FIG. 9G and FIG. 10H through FIG. 10K.

When the start operation to start the cleaning operation is performed (YES at #21), the cleaning operation control unit 44 starts the cleaning operation (#22). The start operation to start the cleaning operation is performed by operating the operating unit 19 with the autonomous mobile robot cleaner 1 being placed at an arbitrary position in a room. In the case of the example shown in FIG. 8A, the autonomous mobile robot cleaner 1 is initially placed at a point O (corner of room) in a room 60 surrounded by walls 50 with its front direction being in the Y-direction (direction parallel to a wall 50a). An obstacle 51 is present substantially at the center of the room 60.

After the start of the cleaning operation, the cleaning operation control unit 44 starts the initial operation (#23). At the initial operation, first of all, the position at which the main body 2 of the autonomous mobile robot cleaner 1 is placed is set as a cleaning start position, wherein the front direction of the main body 2 is set as a main direction while the right direction of the main body 2 is set as an auxiliary direction (#24). In the example shown in FIG. 8A, the point O is set as the cleaning start position, and the Y-direction is set as the main direction while the X-direction perpendicular to the Y-direction is set as the auxiliary direction.

Subsequently, the cleaning operation control unit 44 rotates the left wheel motor 31 and the right wheel motor 32 to turn the main body 2 360 degrees at the current position, i.e., at the cleaning start position (#25). As the main body 2 is turned 360 degrees, map information is updated by the map information creating unit 45 as described above. In the example shown in FIG. 8A, walls 50a and 50b are detected as obstacles. Thus, the map information at this time is as shown in FIG. 9A, wherein the I-direction and J-direction correspond to the X-direction and Y-direction, respectively, in FIG. 8A, and an “already cleaned area” is denoted by the mark “◯” while “areas where an obstacle is present” are denoted by the mark “●”. It is noted that FIG. 9B through FIG. 9G and FIG. 10H through FIG. 10K, which will be described later, show map information in the same manner. A point C shown in FIG. 9A corresponds to the point O shown in FIG. 8A with the J-direction corresponding to the forward direction of the main body 2 (the Y-direction in FIG. 8A).

Thereafter, the cleaning operation control unit 44 rotates the auxiliary brush motor 33, the main brush motor 34, and the dust suction motor 35 so as to start the dust collection operation (#26). Thereby, the initial operation ends.

The cleaning operation control unit 44 then starts the basic cleaning operation (#27). In the basic cleaning operation, first of all, the cleaning operation control unit 44 sets the value of a parameter “V” at “0” (#28). The parameter “V” is provided to be used, when the main body 2 of the autonomous mobile robot cleaner 1 encounters or detects an obstacle, in order to decide a moving direction of the main body 2 for avoiding the obstacle, that is, to decide an avoidance direction. Next, the cleaning operation control unit 44 rotates the left wheel motor 31 and the right wheel motor 32 to move the main body 2 straight in the main direction (#29).

As shown in FIG. 5, the cleaning operation control unit 44 continues the straight movement of the main body 2 (#30). Based on outputs of the front sensors 12a, 12b, and 12c and the ceiling sensor 15 during the straight movement of the main body 2, the cleaning operation control unit 44 determines whether or not an obstacle is detected within a given distance (e.g. 5 cm) in front of the main body 2 (#31). If no obstacle is detected (NO at #31), the cleaning operation control unit 44 continues the straight movement of the main body 2. Accordingly, the autonomous mobile robot cleaner 1 continues to move straight in the main direction until it detects an obstacle in front of the main body 2 thereof. In the example shown in FIG. 8A, the autonomous mobile robot cleaner 1 moves straight from the point O to a point P1 in the Y-direction.

Meanwhile, the map information is updated at all times by the map information creating unit 45 as described above. In the example shown in FIG. 8A, while the autonomous mobile robot cleaner 1 moves from the point O to the point P1, the wall 50a is continuously detected as an obstacle at the left of the main body 2 by the left step sensor 13. When the autonomous mobile robot cleaner 1 reaches the point P1, a wall 50c is detected as an obstacle in front of the main body 2 by the front sensors 12a, 12b, and 12c and the ceiling sensor 15. Thus, the map information at the time the autonomous mobile robot cleaner 1 reaches the point P1 is as shown in FIG. 9B. A point C1 shown in FIG. 9B corresponds to the point P1 shown in FIG. 8A, with the J-direction corresponding to the forward direction of the main body 2 (the Y-direction in FIG. 8A).

When an obstacle is detected within the given distance in front of the main body 2 (YES at #31), i.e., when the straight movement becomes impossible due to the presence of the obstacle, the cleaning operation control unit 44 reads the map information to determine whether or not there is an “area where an obstacle is present” in the rear of the main body 2 (#32). If there is an “area where an obstacle is present” in the rear of the main body 2 (YES at #32), the cleaning operation control unit 44 determines whether the value of “V” is “0” or not (#33). If the value of “V” is “0” (YES at #33), the cleaning operation control unit 44 reads the map information to determine whether or not the area immediately to the right of the main body 2 is either an “already cleaned area” or an “area where an obstacle is present” (#34). On the other hand, if the value of “V” is not “0” (NO at #33), the cleaning operation control unit 44 reads the map information to determine whether or not the area immediately to the left of the main body 2 is either an “already cleaned area” or an “area where an obstacle is present” (#35).

If NO at the step #34, the cleaning operation control unit 44 turns the main body 2 right 90 degrees at the then position, and moves the main body 2 straight (#36). Thereafter, if the main body 2 moves a distance corresponding to the size thereof (YES at #37) or if an obstacle is detected within the given distance in front of the main body 2 (YES at #38), the cleaning operation control unit 44 further turns the main body 2 right 90 degrees at the then position, and moves the main body 2 straight (#39). Then, the cleaning operation control unit 44 sets the value of “V” at “1” (#40), and repeats the process from the step #30.

If NO at the step #35, the cleaning operation control unit 44 turns the main body 2 left 90 degrees at the then position, and moves the main body 2 straight (#41). Thereafter, if the main body 2 moves a distance corresponding to the size thereof (YES at #42) or if an obstacle is detected within the given distance in front of the main body 2 (YES at #43), the cleaning operation control unit 44 further turns the main body 2 left 90 degrees at the then position, and moves the main body 2 straight (#44). Then, the cleaning operation control unit 44 sets the value of “V” at “0” (#45), and repeats the process from the step #30.

As described above, in the example shown in FIG. 8A, the map information at the time the autonomous mobile robot cleaner 1 reaches the point P1 is as shown in FIG. 9B, wherein the point C1 corresponds to the point P1 in FIG. 8A with the J-direction corresponding to the forward direction of the main body 2 (the Y-direction in FIG. 8A). In the map information at this time, there is an “area where an obstacle is present” in the direction opposite to the J-direction when viewed from the point C1 (namely at a point corresponding to an area in the rear of the main body 2), and a point adjacent to the point C1 in the I-direction (namely a point corresponding to an area immediately to the right of the main body 2) is neither an “already cleaned area” nor an “area where an obstacle is present”. The value of “V” at the time the autonomous mobile robot cleaner 1 reaches the point P1 is still “0” as set in the step #28.

When the autonomous mobile robot cleaner 1 reaches the point P1, the results at the steps #32 and #33 are YES and the result at the step #34 is NO. Thus, the process from the step #36 to the step #40 is performed. More particularly, the autonomous mobile robot cleaner 1 turns 90 degrees to the right at the point P1 and moves in the X-direction (auxiliary direction) from the point P1 to a point P2 (by a distance corresponding to the size of the main body 2). Thereafter, the autonomous mobile robot cleaner 1 further turns 90 degrees to the right at the point P2 and moves straight in the direction opposite to the Y-direction (main direction). During the movement of the autonomous mobile robot cleaner 1 from the point P1 to the point P2, a wall 50c is detected as an obstacle by the left step sensor 13. Thus, the map information at the time the autonomous mobile robot cleaner 1 reaches the point P2 is as shown in FIG. 9C. In FIG. 9C, a point C2 corresponds to the point P2 shown in FIG. 8A with the I-direction corresponding to the forward direction of the main body 2 (the X-direction in FIG. 8A).

Thereafter, the autonomous mobile robot cleaner 1 reaches a point P3, where the wall 50b is detected as an obstacle within the given distance in front of the main body 2. The map information at the time the autonomous mobile robot cleaner 1 reaches the point P3 is as shown in FIG. 9D. In FIG. 9D, a point C3 corresponds to the point P3 shown in FIG. 8A with the direction opposite to the J-direction corresponding to the forward direction of the main body 2 (the direction opposite to the Y-direction in FIG. 8A). In the map information at this time, there is an “area where an obstacle is present” in the J-direction when viewed from the point C3 (namely at a point corresponding to an area in the rear of the main body 2), and a point adjacent to the point C3 in the I-direction (namely a point corresponding to an area immediately to the left of the main body 2) is neither an “already cleaned area” nor an “area where an obstacle is present”. At the time the autonomous mobile robot cleaner 1 reaches the point P3, the value of “V” is “1”, which has been changed at the step #40.

When the autonomous mobile robot cleaner 1 reaches the point P3, the result at the step #32 is YES and the results at the steps #33 and #35 are NO. Thus, the process of the steps #41 to #45 is performed. More particularly, the autonomous mobile robot cleaner 1 turns 90 degrees to the left at the point P3 and moves in the X-direction (auxiliary direction) from the point P3 to a point P4 (by a distance corresponding to the size of the main body 2). Thereafter, the autonomous mobile robot cleaner 1 further turns 90 degrees to the left at the point P4 and moves straight in the Y-direction (main direction). During the movement of the autonomous mobile robot cleaner 1 from the point P3 to the point P4, the wall 50b is detected as an obstacle by the right step sensor 14. Thus, the map information at the-time the autonomous mobile robot cleaner 1 reaches the point P4 is as shown in FIG. 9E. In FIG. 9E, a point C4 corresponds to the point P4 shown in FIG. 8A with the I-direction corresponding to the forward direction of the main body 2 (the X-direction in FIG. 8A).

By repeating the process of the steps #30 to #45 via the step #32, so-called zigzag movements of the main body 2, hence the autonomous mobile robot cleaner, are performed such that when the main body 2 detects an obstacle while moving in the main direction, the main body 2 first moves in the auxiliary direction by a distance corresponding to the size of the main body 2, and then moves in the direction opposite to the main direction, and that when the main body 2 detects an obstacle while moving in the direction opposite to the main direction, it first moves in the auxiliary direction by a distance corresponding to the size of the main body 2, and then moves in the main direction. In the example shown in FIG. 8A, the autonomous mobile robot cleaner 1 moves zigzag along a route Z1 from the point O via the points P1, P2, P3, and P4.

If NO at the step #32, the cleaning operation control unit 44 turns the main body 2 180 degrees at the then position and moves the main body 2 straight (#46). Then, if the value of “V” is “0” (YES at #47), the cleaning operation control unit 44 sets the value of “V” at “1” (#48). On the other hand, if the value of “V” is not “0” (NO at #47), the cleaning operation control unit 44 sets the value of “V” at “0” (#49), and repeats the process from the step #30.

In the example shown in FIG. 8A, the autonomous mobile robot cleaner 1 passes through the point P4 to reach a point P5. The map information at the time the autonomous mobile robot cleaner 1 reaches the point P5 is as shown in FIG. 9F. A point C5 shown in FIG. 9F corresponds to the point P5 shown in FIG. 8A with the direction opposite to the J-direction corresponding to the forward direction of the main body 2 (the direction opposite to the Y-direction in FIG. 8A). In the map information at this time, there is no “area where an obstacle is present” in the J-direction when viewed from the point C5 (namely at a point corresponding to an area in the rear of the main body 2). Accordingly, when the autonomous mobile robot cleaner 1 reaches the point P5, the result at the step #32 is NO, so that the process of the steps #46 to #49 is performed. More particularly, the autonomous mobile robot cleaner 1 turns 180 degrees at the point P5 and moves straight from the point P5 in the Y-direction.

Thereafter, the cleaning operation control unit 44 repeats the process from the step #30, whereby the autonomous mobile robot cleaner 1 moves zigzag along a route Z2 from the point P5 while avoiding the obstacle 51 to reach a point P6. Then, the autonomous mobile robot cleaner 1 turns 180 degrees at the point P6, from which it moves zigzag along a route Z3 to reach a point P7. Further, the autonomous mobile robot cleaner 1 turns 180 degrees at the point P7, from which it moves zigzag along a route Z4 to reach a point P8. The map information at the time the autonomous mobile robot cleaner 1 reaches the point P8 is as shown in FIG. 9G. A point C8 shown in FIG. 9G corresponds to the point P8 shown in FIG. 8A with the J-direction corresponding to the forward direction of the main body 2 (the Y-direction in FIG. 8A).

If YES at the step #34 or if YES at the step #35, the basic cleaning operation ends. More particularly, the cleaning operation control unit 44 performs the basic cleaning operation by moving the main body 2 in accordance with the movement procedure as represented by the process of the steps #30 to #49 while controlling the dust collection operation, and ends the basic cleaning operation when the result is YES at the step #34 or step #35. Accordingly, the basic cleaning operation continues as long as the main body 2 of the autonomous mobile robot cleaner 1 can move in accordance with the movement procedure as represented by the process of the steps #30 to #49, and it ends at a position where the main body 2 can no longer move in accordance with the movement procedure.

In the example shown in FIG. 8A, the map information at the time the autonomous mobile robot cleaner 1 reaches the point P8 is as shown in FIG. 9G as described above, wherein the point C8 corresponds to the point P8 in FIG. 8A, and the J-direction corresponds to the forward direction of the main body 2 (the Y-direction in FIG. 8A). In the map information at this time, there is an “area where an obstacle is present” in the direction opposite to the J-direction when viewed from the point C8 (namely at a point corresponding to an area in the rear of the main body 2), and a point adjacent to the point C8 in the I-direction (namely a point corresponding to an area immediately to the right of the main body 2) is an “area where an obstacle is present”. Therefore, when the autonomous mobile robot cleaner 1 reaches the point P8, the result at the step #34 is YES, so that the basic cleaning operation ends.

Thereafter, the cleaning operation control unit 44 searches the map information for an “uncleaned area” (#50). An “Uncleaned area” refers to an area that is neither an “already cleaned area” nor an “area where an obstacle is present” and that the main body 2 of the autonomous robot cleaner 1 is able to reach (namely that is not surrounded by “areas where an obstacle is present”). In the example shown in FIG. 8A, as described above, the basic cleaning operation ends at the time the autonomous mobile robot cleaner 1 reaches the point P8. The map information at this time is shown in FIG. 9G as described above. In this case, points denoted by the mark “Δ” in FIG. 10H are found as “uncleaned areas”.

If an “uncleaned area” is found (YES at #51), the cleaning operation control unit 44 starts the uncleaned area cleaning operation (#52). In the uncleaned area cleaning operation, first of all, the cleaning operation control unit 44 moves the main body 2 of the autonomous mobile robot cleaner 1 into an “uncleaned area” nearest the current position (#53). In the map information shown in FIG. 10H (map information at the time the autonomous mobile robot cleaner 1 reaches the point P8 in the example shown in FIG. 8A), the point C8 corresponds to the current position, and thus a point C9 is the “uncleaned area” nearest the current position. Accordingly, in the example shown in FIG. 8A, the autonomous mobile robot cleaner 1 moves into a point P9 that corresponds to the point C9 in FIG. 10H.

At this time, the direction in which the autonomous mobile robot cleaner 1 can come into the “uncleaned areas” is either the auxiliary direction or the direction opposite to the auxiliary direction (it cannot come thereinto in the main direction or the direction opposite to the main direction) due to the basic cleaning operation performed in accordance with the movement procedure as represented by the process of the steps #30 to #49). If the direction in which the autonomous mobile robot cleaner 1 comes into the “uncleaned areas” is the auxiliary direction (YES at #54), the cleaning operation control unit 44 sets the value of “V” at “0” (#55). On the other hand, if that is the direction opposite to the auxiliary direction (No at #54), the cleaning operation control unit 44 sets the value of “V” at “1” (#56).

Subsequently, the cleaning operation control unit 44 moves the main body 2 of the autonomous mobile robot cleaner 1 straight in the main direction from the position where the main body 2 has come into the “uncleaned areas” (#57), and thereafter performs the process from the step #30 above. In other words, the cleaning operation control unit 44 performs the uncleaned area cleaning operation by moving the main body 2 of the autonomous mobile robot cleaner 1 from a position where the main body 2 comes into “uncleaned areas” in accordance with a movement procedure similar to the basic cleaning operation as represented by the process of the steps #30 to #49 above.

Thereafter, if YES at the step #34 or if YES at the step #35, the cleaning operation control unit 44 ends the uncleaned area cleaning operation, and searches the map information for another “uncleaned area” at the step #50 again. If an “uncleaned area” is found (YES at #51), the cleaning operation control unit 44 repeats the process from the step #52, thereby performing the uncleaned area cleaning operation again. Thus, the uncleaned area cleaning operation is repeated until there is no “uncleaned area”.

In the example shown in FIG. 8A, after the autonomous mobile robot cleaner 1 reaches the point P8 to end the basic cleaning operation, it starts the uncleaned area cleaning operation. The autonomous mobile robot cleaner 1 moves into the point P9 in the X-direction (auxiliary direction), sets the value of “V” at “0”, and moves zigzag along a route Z5 from the point P9 to a point P10.

During the uncleaned area cleaning operation, the map information is updated at all times. The map information at the time the autonomous mobile robot cleaner 1 reaches the point P10 is as shown in FIG. 10I. In FIG. 10I, a point C10 corresponds to the point P10 in FIG. 8A with the direction opposite to the J-direction corresponding to the forward direction of the main body 2 (the direction opposite to the Y-direction in FIG. 8A). In the map information at this time, there is an “area where an obstacle is present” in the J-direction when viewed from the point C10 (namely at a point corresponding to an area in the rear of the main body 2), and a point adjacent to the point C10 in the I-direction (namely a point corresponding to an area immediately to the left of the main body 2) is an “area where an obstacle is present”. Accordingly, when the autonomous mobile robot cleaner 1 reaches the point P10, the result at the step #35 is YES, so that the uncleaned area cleaning operation ends.

As described above, the map information at the time the autonomous mobile robot cleaner 1 reaches the point P10 is shown in FIG. 10I, wherein the point C10 corresponds to the point P10 in FIG. 8A. In this map information, there are left “uncleaned areas” (denoted by the mark “Δ” in FIG. 10I), and a point C11 is an “uncleaned area” nearest the point C10.

Accordingly in the example shown in FIG. 8A, after the autonomous mobile robot cleaner 1 reaches the point P10 to end the uncleaned area cleaning operation, it starts another uncleaned area cleaning operation. The autonomous mobile robot cleaner 1 moves into a point P11, which corresponds to the point C11 in FIG. 10I, in the direction opposite to the X-direction (the direction opposite to the auxiliary direction), sets the value of “V” at “1”, and moves zigzag along a route Z6 from the point P11 to a point P12.

The map information at the time the autonomous mobile robot cleaner 1 reaches the point P12 is as shown in FIG. 10J. In FIG. 10J, a point C12 corresponds to the point P12 shown in FIG. 8A with the J-direction corresponding to the forward direction of the main body 2 (the Y-direction in FIG. 8A). In the map information at this time, there is an “area where an obstacle is present” in the direction opposite to the J-direction when viewed from the point C12 (namely at a point corresponding to an area in the rear of the main body 2), and a point adjacent to the point C12 in the direction opposite to the I-direction (namely a point corresponding to an area immediately to the left of the main body 2) is an “already cleaned area”. Accordingly, when the autonomous mobile robot cleaner 1 reaches the point P12, the result at the step #35 is YES, so that the uncleaned area cleaning operation ends.

As describe above, the map information at the time the autonomous mobile robot cleaner 1 reaches the point P12 is shown in FIG. 10J, wherein the point C12 corresponds to the point P12 in FIG. 8A. In this map information, there are left “uncleaned areas” (denoted by the mark “A” in FIG. 10J), and a point C13 is an “uncleaned area” nearest the point C12.

Accordingly in the example shown in FIG. 8A, after the autonomous mobile robot cleaner 1 reaches the point P12 to end the uncleaned area cleaning operation, it starts another uncleaned area cleaning operation. The autonomous mobile robot cleaner 1 moves into a point P13, which corresponds to the point C13 in FIG. 10J, in the direction opposite to the X-direction (the direction opposite to the auxiliary direction), sets the value of “V” at “1”, and moves zigzag along a route Z7 from the point P13 to a point P14.

The map information at the time the autonomous mobile robot cleaner 1 reaches the point P14 is as shown in FIG. 10K. In FIG. 10K, a point C14 corresponds to the point P14 shown in FIG. 8A with the J-direction corresponding to the forward direction of the main body 2 (the Y-direction in FIG. 8A). In the map information at this time, there is an “area where an obstacle is present” in the direction opposite to the J-direction when viewed from the point C14 (namely at a point corresponding to an area in the rear of the main body 2), and a point adjacent to the point C14 in the direction opposite to the I-direction (namely a point corresponding to an area immediately to the left of the main body 2) is an “area where an obstacle is present”. Accordingly, when the autonomous mobile robot cleaner 1 reaches the point P14, the result at the step #35 is YES, so that the uncleaned area cleaning operation ends.

If no “uncleaned area” is found at the step #51, the cleaning operation control unit 44 starts the edge cleaning operation (#58). In the edge cleaning operation, first of all, the cleaning operation control unit 44 reads the map information to move the main body 2 of the autonomous mobile robot cleaner 1 to a position adjacent to an “area where an obstacle is present” nearest the current position (#59). Then, the cleaning operation control unit 44 moves the main body 2 of the autonomous mobile robot cleaner 1 along the perimeter of the obstacle (#60).

When the cleaning operation control unit 44 completes the movement along the perimeter of the obstacle (YES at #61), it determines whether or not there is another obstacle for which edge cleaning has not been performed yet (#62). If such an obstacle is found (YES at #62), the cleaning operation control unit 44 repeats the process from the step #59 for the obstacle. On the other hand, if there is no obstacle for which edge cleaning has not been performed (NO at #62), that is, if the movement along the perimeter of an obstacle has been performed for all obstacles in a room to be cleaned, the cleaning operation control unit 44 ends the edge cleaning operation, and stops the movement of the main body 2 and the dust collection operation (#63), whereby the cleaning operation ends.

As described above, in the example shown in FIG. 8A, the map information at the time the autonomous mobile robot cleaner 1 reaches the point P14 is as shown in FIG. 10K, wherein the point C14 corresponds to the point P14 in FIG. 8A. In this map information, there is no “uncleaned area” (area that is neither an “already cleaned area” nor an “area where an obstacle is present” and that is not surrounded by “areas where an obstacle is present”).

Accordingly in the example shown in FIG. 8A, when the autonomous mobile robot cleaner 1 reaches the point P14, the result at the step #51 is NO, so that the edge cleaning operation starts. As can be seen from FIG. 8A and FIG. 10K, at the time the autonomous mobile robot cleaner 1 reaches the point P14, the positions of the wall 50 and the obstacle 51 have been completely detected. Further, all the areas other than the wall 50 and the obstacle 51 have been cleaned.

At the time the autonomous mobile robot cleaner 1 reaches the point P14, the point P14 (corresponding to the point C14 in FIG. 10K) is just adjacent to an “area where an obstacle is present”. Therefore, in the example shown in FIG. 8A, the autonomous mobile robot cleaner 1 starts the edge cleaning operation from the point P14. As shown in FIG. 8B, the autonomous mobile robot cleaner 1 starts moving along a route Z8 from the point P14, moves along the perimeter of the wall 50, and then returns to the point P14.

At the time the autonomous mobile robot cleaner 1 returns the point P14 after moving along the perimeter of the wall 50, there is the obstacle 51 for which edge cleaning has not been performed yet. The map information at this time is the same as that shown in FIG. 10K, wherein the point C14 corresponds to the point P14 in FIG. 8B. For the obstacle 51 for which edge cleaning has not been performed yet, it is a point C15 that is adjacent to an “area where an obstacle is present” and nearest the point C14.

Accordingly in the example shown in FIG. 8B, after moving along the perimeter of the wall 50 to return the point P14, the autonomous mobile robot cleaner 1 starts moving along a route Z9 from a point P15 that corresponds to the point C15 in FIG. 10K, and moves along the perimeter of the obstacle 51 to return the point P15. It is noted that while moving along the perimeter of the wall 50 or the obstacle 51, the autonomous mobile robot cleaner 1 keeps a given distance from the wall 50 or the obstacle 51 based on outputs of the left step sensor 13 and the right step sensor 14.

At the time the autonomous mobile robot cleaner 1 returns the point P15 after moving along the perimeter of the obstacle 51, the movement along the perimeter of an obstacle has been performed for all of the obstacles (the wall 50 and the obstacle 51). In other words, there is no obstacle for which edge cleaning has not been performed yet. Thus, the result at the step #62 is NO, so that the cleaning operation ends via the process of the step #63.

In the example shown in FIG. 8A, any “uncleaned area” is not newly detected during the uncleaned area cleaning operation, but there may be a case where another “uncleaned area” is detected during the uncleaned area cleaning operation, depending on the positions and shapes of obstacles such as the wall 50 and the obstacle 51 and the number of the obstacles as well as where the cleaning start position O is set. Even in such a case, by repeating the process of the steps #50 to #57, the autonomous mobile robot cleaner 1 detects all the positions of the obstacles such as the wall 50 and the obstacle 51 so as to clean all of the areas other than the areas where the obstacles such as the wall 50 and the obstacle 51 are present. Thereafter, by the process from the step #58, the autonomous mobile robot cleaner 1 cleans the edges of the obstacles such as the wall 50 and the obstacle 51.

As is evident from the foregoing, the autonomous mobile robot cleaner 1 cleans e.g. a room while moving in accordance with a predetermined movement procedure based on the basic cleaning operation. During the basic cleaning operation, the autonomous mobile robot cleaner 1 creates map information indicating already cleaned areas and areas where an obstacle is present. Thereafter, based on the map information, the autonomous mobile robot cleaner 1 cleans uncleaned areas, which cannot be cleaned by the basic cleaning operation, by the uncleaned area cleaning operation. During the uncleaned area cleaning operation, the autonomous mobile robot cleaner 1 continuously creates the map information, so that the uncleaned area cleaning operation is repeated until there is no uncleaned area. When there is no uncleaned area, the room has been entirely cleaned with the positions of all obstacles including walls in the room having been detected. After the autonomous mobile robot cleaner 1 cleans the entire room by the basic cleaning operation and the uncleaned area cleaning operation, it cleans the edges of the obstacles by the edge cleaning operation, based on the map information at that time.

Accordingly, the autonomous mobile robot cleaner 1 cleans the edge of an obstacle twice by the basic cleaning operation and the edge cleaning operation so as to thoroughly clean the edge of the obstacle. Moreover, in the edge cleaning operation, the autonomous mobile robot cleaner 1 cleans the edge of the obstacle while moving along the perimeter of the obstacle, thereby cleaning the edge of the obstacle more thoroughly. Since the map information is created during the cleaning operations, the above cleaning operations can be performed without the need for input of data about the shape of a room to be cleaned and an obstacle therein for example. Further, by repeating the uncleaned area cleaning operation until no area is left uncleaned, based on map information updated during the cleaning operations, the autonomous mobile robot cleaner 1 can clean an entire room, of whatever shape and in whatever manner obstacles are arranged therein, and then clean the edges of all the obstacles.

The autonomous mobile robot cleaner 1 determines its moving distance and position based on an output of the acceleration sensor 36. Therefore, even if the left wheel 3 or the right wheel 4 slips, the moving distance and position can be determined precisely. Accordingly, the autonomous mobile robot cleaner 1 can precisely control movements while creating precise map information, thereby ensuring thorough cleaning of an entire room.

The controller of the autonomous mobile robot cleaner 1 manages the map information like a matrix with areas to be cleaned (areas in a room) classified into three categories, i.e., areas where an obstacle is present, already cleaned areas, and other areas, in units of the size of the main body 2. This can reduce required capacity of the map information memory 41. In the uncleaned area cleaning operation as well as in the basic cleaning operation, the autonomous mobile robot cleaner 1 performs movement control such that it repeats moving in a direction, moving sideways when detecting an obstacle, and then moving in the opposite direction. Thus, it can be minimized to move redundantly while map information creation logic and movement control logic can be simplified. Accordingly, quick determination and quick movement can be achieved.

The present invention has been described above using a presently preferred embodiment, but those skilled in the art will appreciate that various modifications are possible. Accordingly, all such modifications are intended to be included within the sprit and scope of the present invention. For example, the movement pattern in the basic cleaning operation and the uncleaned area cleaning operation is not limited to such pattern in accordance with the movement procedure as represented by the process of the steps #30 to #49 above. It can be a spiral movement pattern or any arbitrary movement pattern. The map information is not necessarily created based on information about the position of an obstacle and the position of the main body of the autonomous mobile robot cleaner that is obtained via the sensors during a cleaning operation, but can be created based on data about the shape of a room and the position of an obstacle that is input. The direction of movement along the perimeter of an obstacle in the edge cleaning operation can be clockwise or counterclockwise. During movement to a position to start the uncleaned area cleaning operation or the edge cleaning operation, the autonomous mobile robot cleaner can perform dust collection operation or suspend it.

This application is based on Japanese patent application 2004-22410 filed in Japan dated Jan. 30, 2004, the contents of which are hereby incorporated by references.

1. An autonomous mobile robot cleaner having a main body, comprising:
an obstacle detection means to detect an obstacle around the main body;
a moving means to move and turn the main body;
a cleaning means to clean an area in which the main body moves;
a cleaning operation control means to control the moving means and the cleaning means based on an output of the obstacle detection means so as to clean, while moving the main body, the area in which the main body moves; and
a map information memory means to store map information about an area where an obstacle is present,
wherein the cleaning operation control means performs a basic cleaning operation to move the main body in accordance with a predetermined movement procedure, and
wherein thereafter the cleaning operation control means performs an edge cleaning operation to move the main body along the perimeter of the obstacle based on the map information stored in the map information memory means.

2. The autonomous mobile robot cleaner according to claim 1, further comprising:
a moving distance detection means to detect a moving distance of the main body;
a moving direction detection means to detect a moving direction of the main body; and
a map information creating means to create the map information based on outputs of the obstacle detection means, the moving distance detection means, and the moving direction detection means,
wherein the cleaning operation control means performs the edge cleaning operation based on map information updated during the cleaning operation by the map information creating means.

3. The autonomous mobile robot cleaner according to claim 2, wherein the map information creating means creates, during the basic cleaning operation, map information indicating an already cleaned area and an area where an obstacle is present.

4. The autonomous mobile robot cleaner according to claim 2,
wherein cleaning operations controlled by the cleaning operation control means include:
(i) an initial operation to turn the main body 360 degrees at a cleaning start position for detection of presence or absence of an obstacle around the cleaning start position;
(ii) the basic cleaning operation to perform cleaning while moving the main body from the cleaning start position in accordance with the predetermined movement procedure;
(iii) an uncleaned area cleaning operation to clean, after the basic cleaning operation, an uncleaned area that cannot be cleaned by the basic cleaning operation; and
(iv) the edge cleaning operation to clean an edge of an obstacle while moving the main body along the perimeter of the obstacle.

5. The autonomous mobile robot cleaner according to claim 2,
wherein after the basic cleaning operation, the cleaning operation control means performs an uncleaned area cleaning operation to move the main body in an area that is left uncleaned, based on map information updated during the basic cleaning operation by the map information creating means,
wherein the cleaning operation control means repeats the uncleaned area cleaning operation, until there is no uncleaned area, based on map information updated during the cleaning operations by the map information creating means, and
wherein after there is no uncleaned area, the cleaning operation control means performs the edge cleaning operation to move the main body along the perimeter of an obstacle based on updated map information.
